(19) United States
(12) Patent Application Publication
(10) Pub. No.: US 2021/0177023 A1
(43) Pub. Date: Jun. 17, 2021

(54) COMPOUNDS FOR SWEETNESS ENHANCEMENT

(71) Applicant: International Flavors & Fragrances Inc., New York, NY (US)

(72) Inventors: Ajay Pratap SINGH, Highland Park, NJ (US); Hassan Mustaq UBAIDEEN, Aberdeen, NJ (US); Xiao-Qing TANG, Holmdel, NJ (US); Michelle Eve HUBER, Cream Ridge, NJ (US); Thumpalasseril V. JOHN, Morganville, NJ (US)

(73) Assignee: International Flavors & Fragrances Inc., New York, NY (US)

(21) Appl. No.: 16/710,334

(22) Filed: Dec. 11, 2019

(51) Int. Cl. A23L 27/30; A23L 27/00

(52) U.S. Cl. CPC A23L 27/36; A23L 27/84; A23V 2002/00; A23L 27/34; A23L 27/88

(57) ABSTRACT

The use of a secoiridoid glucoside or a polyphenol compound to enhance the sweetness, mask the bitter off-taste and/or improve the flavor perception of a sweetness modifier and to decrease the amount of a sweetness modifier used in a consumable is provided.

### BACKGROUND OF INVENTION

Reducing sugar content in food and beverages has become a necessity in the food industry. Food and beverage manufacturers generally use non-caloric, high-intensity sweetness modifiers, such as rebaudioside A (Reb A), aspartame, saccharin, glycosylated steviol glycosides, etc., to partially or completely replace sugar. However, these sweetness modifiers may exhibit undesirable taste attributes such as delayed onset of sweetness, bitter and astringent aftertaste, and lack of body and mouthfeel. Consequently, sweetness enhancers have become valuable tools, which reduce the use of sugar and/or sweetness modifiers, in achieving the desired sweetness intensity and mouthfeel with reduced off-taste.

Sweetness enhancers have been described in the prior art. For example, WO 2013/143822 teaches the use of adenosine as sweetness enhancer for certain sugars; EP 2606747 describes the use of deoxycholic acid or a derivative thereof for enhancing the sweetness of consumables; WO 2013/077668 describes the sweetness enhancing effect of a glycan or glycopeptide derived from soy sauce; WO 2012/107203 teaches the use of nobiletin or a derivative or a hydrate thereof as a sweetener or sweetness enhancer; WO 2009/023975 describes the use of iso-mogroside V as a sweetener and sweetness enhancer; US 2008/0242740 teaches aroma compositions of alkamides with hesperetin and/or 4-hydroxydihydrochalcones for enhancing sweet sensory impressions; and WO 2007/014879 and WO 2007/107596 respectively teach the use of hesperetin and 4-hydroxydihydrochalcones for enhancing the sweet taste of a sweet-tasting substance or sweet olfactory impression of a flavoring.

### SUMMARY OF THE INVENTION

This invention provides a method of enhancing the sweetness, masking the bitter off-taste and/or improving the flavor perception of a sweetness modifier by adding an olfactory effective amount of a secoiridoid glucoside or a polyphenol compound.

The secoiridoid glucosides of the present invention are represented by Formula A set forth below:

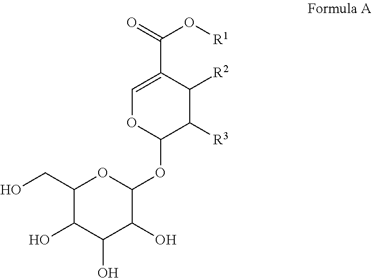

wherein R¹ represents hydrogen or a C1-8 alkyl, alkenyl or aryl optionally substituted with a hydroxyl group; and wherein one of R² and R³ represents ethyl, ethylidene, hydroxymethyl, hydroxymethylene, hydroxyethyl, hydroxyethylidene, carboxymethyl, carboxymethylene, methoxy-2-oxoethyl, methoxy-2-oxoethylidene, acetoxyethyl or acetoxyethylidene with the other represents hydroxyphenethyl propionate or hydroxyphenethyl acrylate optionally substituted with a methoxy or an additional hydroxyl group.

Another embodiment of the present invention relates to a subgenus of the secoiridoid glucosides represented by Formula A1 set forth below:

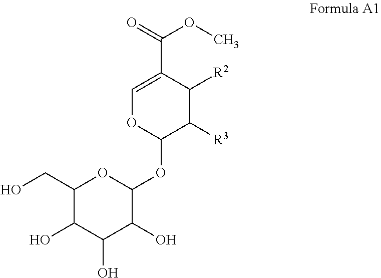

wherein R² and R³ are defined as above.

The polyphenol compounds of the present invention are represented by Formula B set forth below:

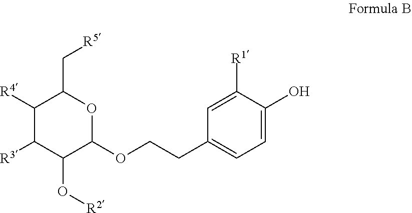

wherein R^{1′} is selected from the group consisting of hydrogen, a hydroxy group and a methoxy group;

R^{2′} is selected from the group consisting of hydrogen, an ethanone group and a sugar group;

R^{3′}, R^{4′} and R^{5′} each independently and distinctly represents a hydroxy group, 3-(3,4-dihydroxyphenyl)acrylate or the sugar group, and

wherein the sugar group is selected from the group consisting of 6-deoxy-hexopyranose, hexopyranose,6-deoxy-hexopyranose dimer and hexopyranose dimer.

In one embodiment, the present invention is directed to a method of enhancing the sweetness, masking the bitter off-taste and/or improving the flavor perception of a sweetness modifier comprising the step of adding an olfactory effective amount of the secoiridoid glucoside or the polyphenol compound provided above.

In another embodiment, the present invention is directed to a method enhancing the sweetness, masking the bitter off-taste and/or improving the flavor perception of a sweetness modifier comprising the step of adding an olfactory effective amount of a botanical extract comprising the secoiridoid glucoside or the polyphenol compound provided above.

In another embodiment, the present invention is directed to a composition comprising a sweetness modifier and an olfactory effective amount of the secoiridoid glucoside or the polyphenol compound provided above.

In another embodiment, the present invention is directed to a composition comprising a sweetness modifier and an olfactory effective amount of a botanical extract comprising the secoiridoid glucoside or the polyphenol compound provided above.

In another embodiment, the present invention is directed to a consumable comprising a sweetness modifier and an olfactory effective amount of the secoiridoid glucoside or the polyphenol compound provided above.

In another embodiment, the present invention is directed to a consumable comprising a sweetness modifier and an olfactory effective amount of a botanical extract comprising the secoiridoid glucoside or the polyphenol compound provided above.

These and other embodiments of the present invention will be apparent by reading the following specification.

### DETAILED DESCRIPTION OF THE INVENTION

The secoiridoid glucosides of the present invention can be, for example, but not limited to, represented by the following structures:

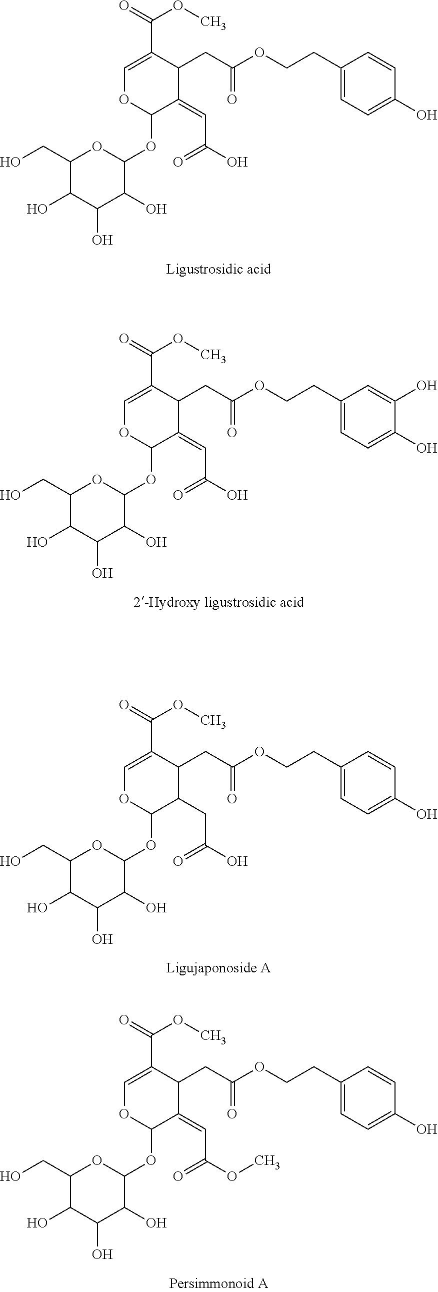 [SMILES: COC(=O)C1=COC(OC2OC(CO)C(O)C(O)C2O)/C(=C\C(=O)O)C1CC(=O)OCCc1ccc(O)cc1 ; COC(=O)C1=COC(OC2OC(CO)C(O)C(O)C2O)/C(=C\C(=O)O)C1CC(=O)OCCc1ccc(O)c(O)c1 ; COC(=O)C1=COC(OC2OC(CO)C(O)C(O)C2O)C(CC(=O)O)C1CC(=O)OCCc1ccc(O)cc1 ; COC(=O)/C=C1\C(OC2OC(CO)C(O)C(O)C2O)OC=C(C(=O)OC)C1CC(=O)OCCc1ccc(O)cc1]

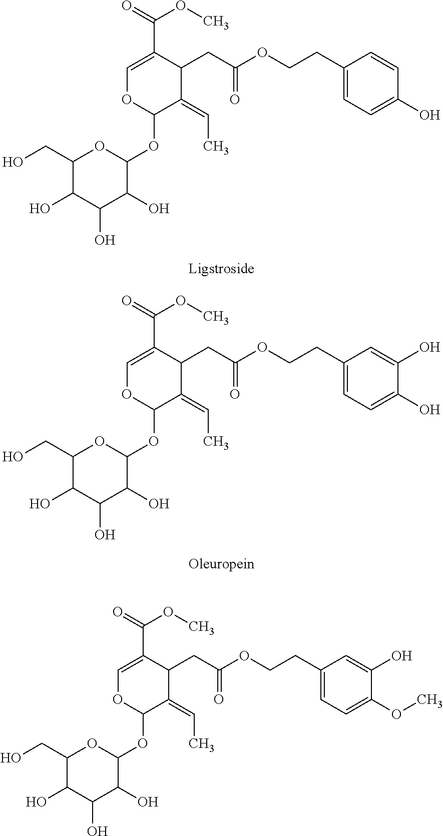 [SMILES: C/C=C1\C(OC2OC(CO)C(O)C(O)C2O)OC=C(C(=O)OC)C1CC(=O)OCCc1ccc(O)cc1 ; C/C=C1\C(OC2OC(CO)C(O)C(O)C2O)OC=C(C(=O)OC)C1CC(=O)OCCc1ccc(O)c(O)c1 ; C/C=C1\C(OC2OC(CO)C(O)C(O)C2O)OC=C(C(=O)OC)C1CC(=O)OCCc1ccc(OC)c(O)c1]

### 2-(3-Hydroxy-4-ethoxyphenyl)ethyl (2S,3E,4S)-3-ethylidene-2-(β-D-glucopyranosyloxy)-3,4-dihydro-5-(methoxycarbonyl)-2H-pyran-4-acetate

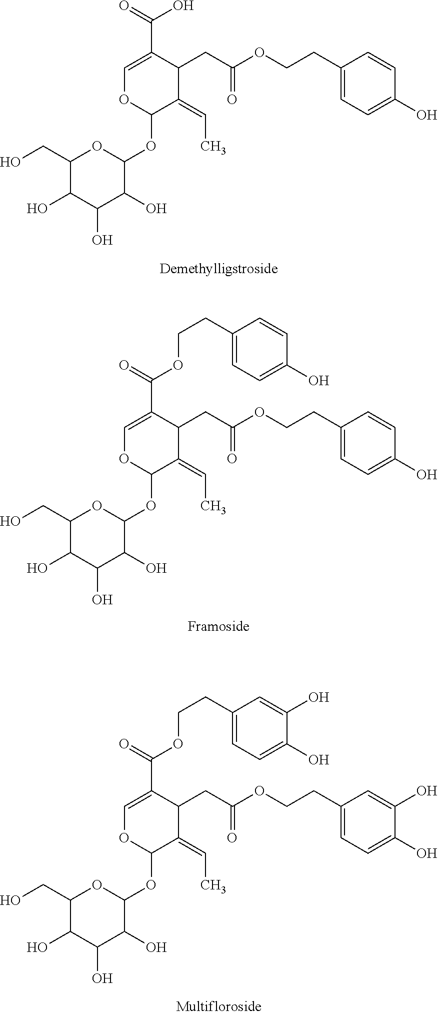 [SMILES: C/C=C1\C(OC2OC(CO)C(O)C(O)C2O)OC=C(C(=O)O)C1CC(=O)OCCc1ccc(O)cc1 ; C/C=C1\C(OC2OC(CO)C(O)C(O)C2O)OC=C(C(=O)OCCc2ccc(O)cc2)C1CC(=O)OCCc1ccc(O)cc1 ; C/C=C1\C(OC2OC(CO)C(O)C(O)C2O)OC=C(C(=O)OCCc2ccc(O)c(O)c2)C1CC(=O)OCCc1ccc(O)c(O)c1]

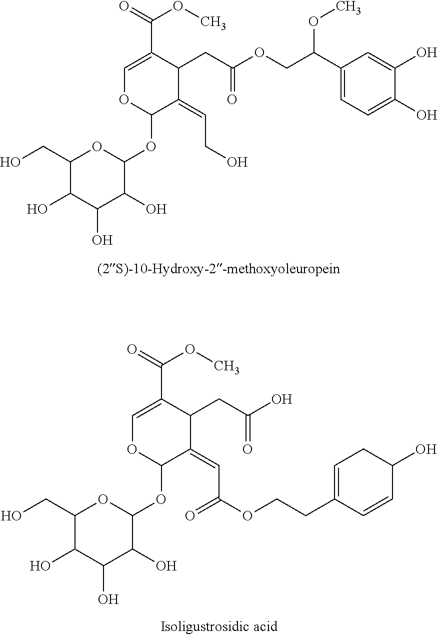 [SMILES: COC(=O)C1=COC(OC2OC(CO)C(O)C(O)C2O)/C(=C\CO)C1CC(=O)OCC(OC)c1ccc(O)c(O)c1 ; COC(=O)C1=COC(OC2OC(CO)C(O)C(O)C2O)/C(=C\C(=O)OCCC2=CCC(O)C=C2)C1CC(=O)O]

The polyphenol compounds of the present invention can be, for example, but not limited to, represented by the following structures:

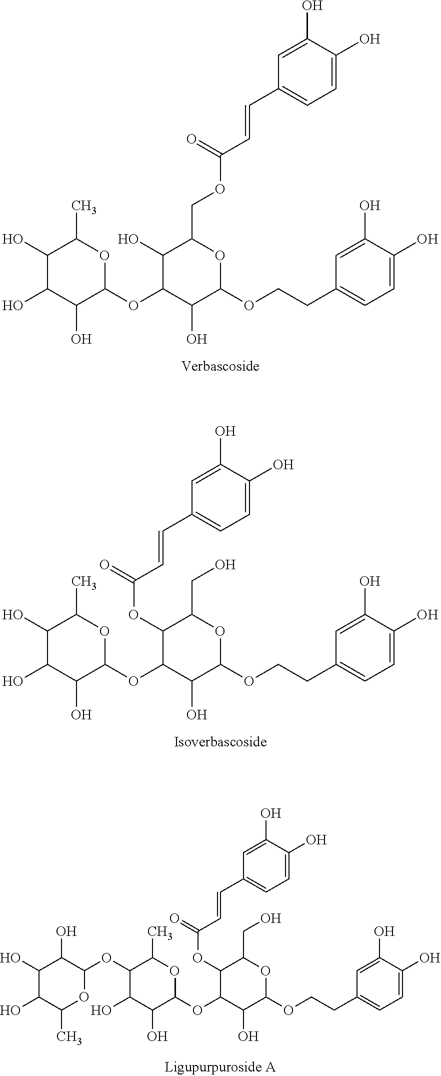 [SMILES: CC1OC(OC2C(O)C(COC(=O)/C=C/c3ccc(O)c(O)c3)OC(OCCc3ccc(O)c(O)c3)C2O)C(O)C(O)C1O ; CC1OC(OC2C(O)C(OCCc3ccc(O)c(O)c3)OC(CO)C2OC(=O)/C=C/c2ccc(O)c(O)c2)C(O)C(O)C1O ; CC1OC(OC2C(C)OC(OC3C(O)C(OCCc4ccc(O)c(O)c4)OC(CO)C3OC(=O)/C=C/c3ccc(O)c(O)c3)C(O)C2O)C(O)C(O)C1O]

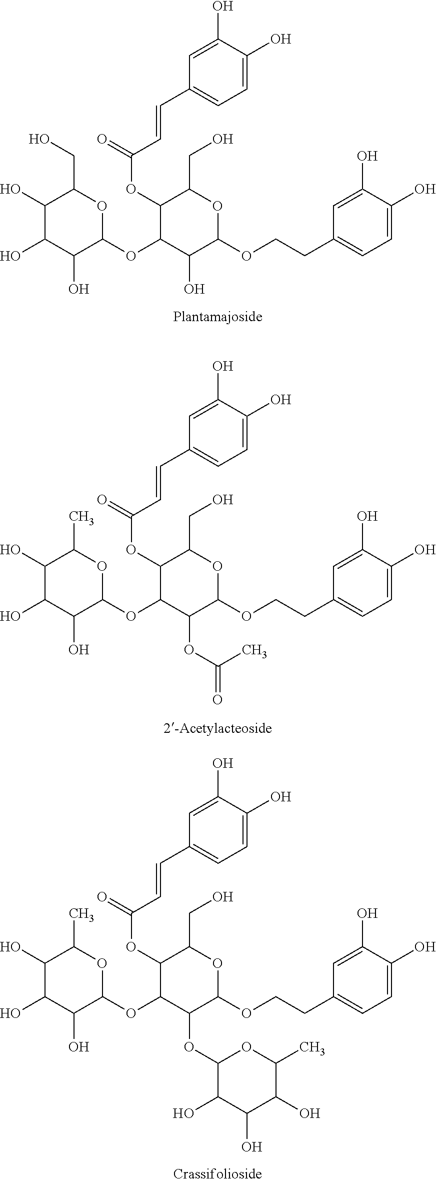 [SMILES: O=C(/C=C/c1ccc(O)c(O)c1)OC1C(CO)OC(OCCc2ccc(O)c(O)c2)C(O)C1OC1OC(CO)C(O)C(O)C1O ; CC(=O)OC1C(OCCc2ccc(O)c(O)c2)OC(CO)C(OC(=O)/C=C/c2ccc(O)c(O)c2)C1OC1OC(C)C(O)C(O)C1O ; CC1OC(OC2C(OCCc3ccc(O)c(O)c3)OC(CO)C(OC(=O)/C=C/c3ccc(O)c(O)c3)C2OC2OC(C)C(O)C(O)C2O)C(O)C(O)C1O]

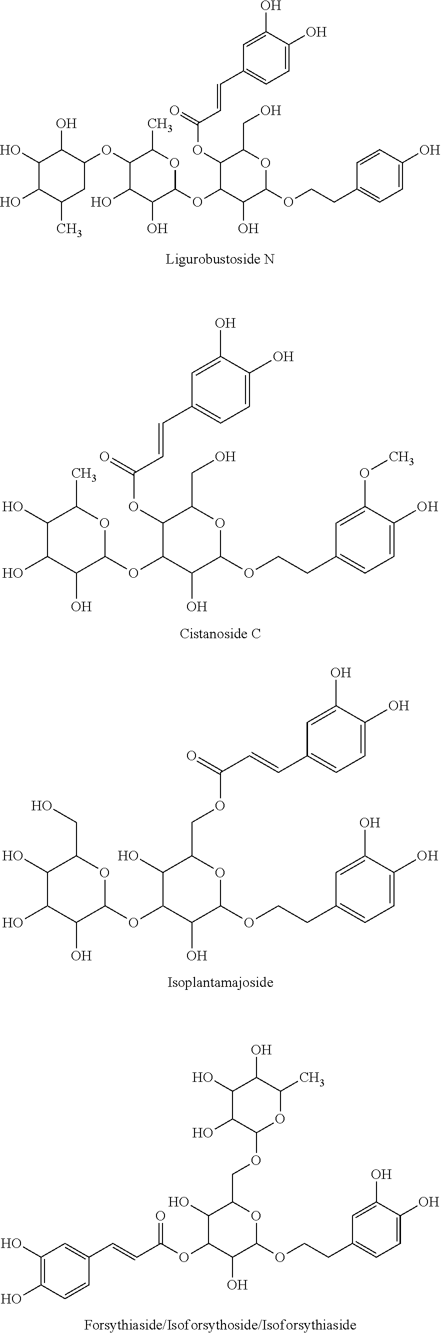 [SMILES: CC1CC(OC2C(C)OC(OC3C(O)C(OCCc4ccc(O)cc4)OC(CO)C3OC(=O)/C=C/c3ccc(O)c(O)c3)C(O)C2O)C(O)C(O)C1O ; COc1cc(CCOC2OC(CO)C(OC(=O)/C=C/c3ccc(O)c(O)c3)C(OC3OC(C)C(O)C(O)C3O)C2O)ccc1O ; O=C(/C=C/c1ccc(O)c(O)c1)OCC1OC(OCCc2ccc(O)c(O)c2)C(O)C(OC2OC(CO)C(O)C(O)C2O)C1O ; CC1OC(OCC2OC(OCCc3ccc(O)c(O)c3)C(O)C(OC(=O)/C=C/c3ccc(O)c(O)c3)C2O)C(O)C(O)C1O]

Ligustrosidic acid, [3-(carboxymethylene)-2-(β-D-glucopyranosyloxy)-3,4-dihydro-5-(methoxycarbonyl)]-2H-pyran-4-acetic acid-α-[2-(4-hydroxyphenyl)ethyl] ester, and its derivative, 2′-hydroxy ligustrosidic acid, are naturally constituents in Ligustrum lucidum Ait and Ligustrum japonicum. 2′-Hydroxy ligustrosidic acid was also reported in genus Cyperus and olive (Li et al., Molecules (2017), 22(5): 689; Gao et al., Records of Natural Products (2015), 9(3): 323-328; Kikuchi et al., Yakugaku Zasshi (1985), 105(2): 142-147; Gao et al., Chemistry of Natural Compounds (2017), 53(3): 553-554; Cheng et al., Article in Asian Journal of Chemistry (2014), 26(13): 3967-3970; Rubio-Senent et al., Journal of agricultural and food chemistry (2013), 61(6): 1235-1248).

Ligustrum lucidum Ait has been used as a traditional Chinese medicine over thousands of years in invigorating liver and kidney (Hu et al., Oncology Reports (2014), 32(3):1037-1042). Other species such as Ligustrum liukiuense, Ligustrum lucidum, Ligustrum morrisonense, Ligustrum pricei, and Ligustrum sinense have been widely used as tea or herbal medicine in Europe, China and Japan (Wu et al. Food Chemistry (2011), 127(2), 564-571). The extract of Ligustrum sinense was also evaluated in a combined treatment of Pseudomonas aeruginosa PA01 biofilm formation with gentamicin sulphate (Yang et al. Journal of environmental biology (2013), 34(2 Spec No), 451-457). Thus, it has been suggested but not proven that 2′-hydroxy ligustrosidic acid may possess antioxidant function (Gao et al., Records of Natural Products (2015), 9(3): 323-328; Gao et al., Chemistry of Natural Compounds (2017), 53(3): 553-554). However, no function has ever been reported or even suggested for ligustrosidic acid. In the present invention, ligustrosidic acid and 2′-hydroxy ligustrosidic acid have been for the first time identified in genus Chaenomeles. Ligujaponoside A is a natural constituent in genus Ligustrum such as Ligustrum japonicum, which was evaluated for immunosuppressive effects (Ngo et al., Photochemistry (2017), 141: 147-155). Persimmonoid A was identified in genus Diospyros such as Diospyros kaki. Persimmonoid A-containing persimmon fruits were reported as an antioxidant and neuroprotective functional food (Huang et al., Journal of Functional Foods (2016), 24: 183-195). Ligstroside and oleuropein were both identified, for example, in olive tree leaves (Olea europaea L.), which have been widely used in traditional remedies for a wide range of pharmacologic and health-promoting properties including antiarrhythmic, spasmolytic, immune stimulant, cardioprotective, hypotensive, antioxidant and anti-inflammatory effects (Salem et al., Journal of Food Processing and Preservation (2015), 39(6): 3128-3136). 2-(3-Hydroxy-4-methoxyphenyl)ethyl (2S,3E,4S)-3-ethylidene-2-(β-D-glucopyranosyloxy)-3,4-dihydro-5-(methoxycarbonyl)-2H-pyran-4-acetate was identified in genus Fraxinus such as Fraxinus rhynchophylla and genus Olea such as Olea europaea (Si et al., Chemistry of Natural Compounds (2009), 45(6): 814-816; Ji et al., Tianran Chanwu Yanjiu Yu Kaifa (2007), 19(3): 361-364). Demethylligstroside is a natural constituent in genus Syringa such as Syringa vulgaris, which was reported to be suitable for pharmacological and cosmetic applications (Toth et al., Biomedical Chromatography (2016), 30(6): 923-932), genus Olea such as Olea europaea, which may possess antioxidant function (Rubio-Senent et al., Journal of Agricultural and Food Chemistry (2012), 60(5): 1175-1186), genus Ligustrum such as Ligustrum lucidum (Yang, et al., Journal of Biosciences (2015), 70(9-10): 237-241) and genus Fraxinus such as Fraxinus excelsior and Fraxinus americana (Cleary et al., Phytochemistry (2014), 102: 115-125; Takenaka et al., Phytochemistry (2000), 55(3): 275-284). Framoside is also a natural constituent in genus Fraxinus such as Fraxinus Cortex, Fraxinus formosana, Fraxinus ornus, Fraxinus oxycarpa and Fraxinus uhdei, and may possess antibacterial and anti-inflammatory activity (Weng et al., Zhongguo Yaowu Huaxue Zazhi (2014), 24(1), 40-47; Tanahashi et al., Phytochemistry (1992), 32(1): 133-136; Iossifova et al., Phytochemistry (1998), 49(5): 1329-1332; Ivanovska et al., Phytotherapy Research (1996), 10(7): 555-558; Perez-Castorena et al., Revista Latinoamericana de Quimica (1997), 25(2): 86-90). Multifloroside was identified in Jasminum multiflorum and reported to possess potential antimalarial function (Shen et al., Phytochemistry (1990), 29(9): 2905-2912; Rifai et al., Asian Journal of Pharmaceutical and Clinical Research (2017), 10(Spec.Iss.5): 130-133). (2″S)-10-Hydroxy-2″-methoxyoleuropein and isoligustrosidic acid were both identified in genus Ligustrum such as Ligustrum vulgare and Ligustrum lucidum (Tanahashi et al., Phytochemistry (Elsevier) (2009), 70(17-18), 2072-2077; Aoki et al., Chemical & Pharmaceutical Bulletin (2012), 60(2), 251-256)

Accordingly, the present invention provides a method of using a secoiridoid glucoside such as ligustrosidic acid, 2′-hydroxy ligustrosidic acid, ligujaponoside A, persimmonoid A, ligstroside, oleuropein, 2-(3-hydroxy-4-methoxyphenyl)ethyl (2S,3E,4S)-3-ethylidene-2-(β-D-glucopyranosyloxy)-3,4-dihydro-5-(methoxycarbonyl)-2H-pyran-4-acetate, demethylligstroside, framoside, multifloroside, (2″S)-10-hydroxy-2″-methoxyoleuropein, isoligustrosidic, a salt thereof or a mixture thereof to enhance the sweetness, mask the bitter off-taste and/or improve the flavor perception of a sweetness modifier and decrease the amount of a sweetness modifier used in a consumable.

The term “a secoiridoid glucoside” is understood to mean a compound represented by Formula A and Formula A1 provided above such as ligustrosidic acid, 2′-hydroxy ligustrosidic acid, ligujaponoside A, persimmonoid A, ligstroside, oleuropein, 2-(3-hydroxy-4-methoxyphenyl)ethyl (2S,3E,4S)-3-ethylidene-2-(β-D-glucopyranosyloxy)-3,4-dihydro-5-(methoxycarbonyl)-2H-pyran-4-acetate, demethylligstroside, framoside, multifloroside, (2″S)-10-hydroxy-2″-methoxyoleuropein, isoligustrosidic, a salt thereof or a mixture thereof.

Further, the secoiridoid glucoside of the present invention has also been found to possess an unexpected and advantageous use in food. In particular, the secoiridoid glucoside of the present invention has been found to enhance the sweetness, mask the bitter off-taste and/or improve the flavor perception of sweetness modifiers without undesirable off-notes. The term “a secoiridoid glucoside” is understood to mean one or more of the secoiridoid glucoside as described herein.

In the present invention, ligustrosidic acid and 2′-hydroxy ligustrosidic acid are available commercially and can also be an isolated and purified form a botanical extract, for example, genus Ligustrum such as Ligustrum amamianum, Ligustrum amurense, Ligustrum angustum, Ligustrum australianum, Ligustrum chenaultii, Ligustrum compactum, Ligustrum confusum, Ligustrum delavayanum, Ligustrum expansum, Ligustrum gracile, Ligustrum henryi, Ligustrum ibota, Ligustrum indicum, Ligustrum japonicum, Ligustrum leucanthum, Ligustrum lianum, Ligustrum liukiuense, Ligustrum longitubum, Ligustrum lucidum, Ligustrum massalongianum, Ligustrum micranthum, Ligustrum microcarpum, Ligustrum morrisonense, Ligustrum obovatilimbum, Ligustrum obtusifolium, Ligustrum ovalifolium, Ligustrum pedunculare, Ligustrum pricei, Ligustrum punctifolium, Ligustrum quihoui, Ligustrum retusum, Ligustrum robustum, Ligustrum sempervirens, Ligustrum sinense, Ligustrum strongylophyllum, Ligustrum tenuipes, Ligustrum tschonoskii, Ligustrum vulgare, Ligustrum xingrenense and Ligustrum yunguiense, genus Cyperus such as Cyperus rotundus, genus Olea such as Olea europaea and genus Chaenomeles such as Chaenomeles cathayensis, Chaenomeles japonica and Chaenomeles speciosa. A salt form, for example, includes ligustrosidic acid methyl ester.

Verbascoside, (E)-2-(3,4-dihydroxyphenyl)ethyl 3-O-(6-deoxy-α-L-mannopyranosyl)-4-[3-(3,4-dihydroxyphenyl)-2-propenoate]-β-D-Glucopyranoside; and its structural isomer isoverbascoside are naturally constituents of genus Campsis such as Campsis grandiflora (Imakura et al., Phytochemistry (1985), 24(I): 139-146), genus Conandron such as Conandron ramondioides (Nonaka et al., Phytochemistry (1977), 16(8):1265-1267), genus Ligustrum such as Ligustrum expansum (Wong et al., Journal of Agricultural and Food Chemistry (2001), 49(6): 3113-3119), genus Lippia such as Lippia salviaefolia, Lippia velutina, Lippia balansae, Lippia lasiocalycina, Lippia lupulina and Lippia sidoides (Funari et al., Food Chemistry (2012a), 135(3): 861-2118; Funari et al., Journal of Chromatography A (2012b), 1259:167-178), genus Mitraria such asMitraria coccinea (Cardenas et al. Liebigs Annalen der Chemie. (1992), 7(24): 665-668), genus Osmanthus (CN 103768152A; CN 107094969A), Olea such as Olea europaea (Ramirez et al., Food Chemistry (2016), 1(206):204-9; Sousa et al., The Journal of the American Oil Chemists' Society (2014), 91(4): 599-611) and genus Phyla such as Phyla dulcis (Kaneda et al., Journal of Natural Products (1992), 55(8): 1136-1141).

Some of these species are used in ethnobotany worldwide as antioxidant food and antiseptic remedies such as mouth and throat infections (Wong et al., Journal of Agricultural and Food Chemistry (2001), 49(6): 3113-3119; Funari et al., Food Chemistry (2012a), 135(3): 861-2118; CN 103768152A; CN 107094969A). However, no function has ever been reported or suggested for verbascoside or isoverbascoside. Yet it is known that verbascoside is a bitter phenylpropanoid glycoside (Kaneda et al., Journal of Natural Products (1992), 55(8): 1136-1141) and has been shown to be responsible for the bitter taste in many fruits and vegetables such as fresh olives (Ramirez et al., Food Chemistry (2016), 1(206):204-9). In the present invention, verbascoside and isoverbascoside have been for the first time identified in genus Chaenomeles.

Ligupurpuroside A was identified in genus Artemisia such as Artemisia terrae-albae, genus Ganoderma such as Ganoderma lucidum, genus Geranium such as Geranium collinum, genus Haplophyllum such as Haplophyllum sieversii, genus Ilex such as Ilex kudingcha and Ilex cornuta, genus Ligustrum such as Ligustrum bpurpurascens, Ligustrum japonicum, Ligustrum lucidum, Ligustrum pedunculare, Ligustrum purpurascens and Ligustrum robustum, genus Nepeta such as Nepeta pannonica, genus Schisandra, genus Tamarix such as Tamarix arceuthoides and genus Verbascum such as Verbascum songoricum. Ligupurpuroside A has also been reported for anti-aging, antioxidant, immunomodulatory, anti-algal, anti-fungal and phytotoxic effect, anti-proliferative activity in murine melanoma cells as well as alleviation of body weight (Cao et al., Zhongcaoyao (2006), 37(5): 691-694; CN 101357145 B; CN 105362281 A; CN 106581032 A; Fan et al., Phytochemistry Letters (2015), 13: 177-181; He et al., Journal of Natural Products (2003), 66(6): 851-854; Kinjo et al., Natural Medicines (Tokyo, Japan) (2002), 56(4): 136-138; Kobaisy et al., ACS Symposium Series (2006), 927(Natural Products for Pest Management): 142-151; Li et al., Zhongyaocai (2007), 30(5): 543-546; Song et al. Journal of Ethnopharmacology (2012), 144(3): 584-591; Zhu et al., Journal of Agricultural and Food Chemistry (2009), 57(14): 6082-6089).

Plantamajoside was identified in genus Aeschynanthus, genus Aloysia such as Aloysia citrodora, genus Boschniakia such as Boschniakia himalaica, genus Chirita such as Chirita eburnea, genus Cistanche, genus Digitalis such as Digitalis lanata and Digitalis purpurea, genus Forsythia, genus Hemiphragma such as Hemiphragma heterophyllum, genus Lagotis such as Lagotis brevituba, Lagotis stolonifera and Lagotis integrifolia, genus Lamiophlomis such as Lamiophlomis rotate, genus Massularia such as Massularia acuminate, genus Neopicrorhiza such as Neopicrorhiza sciphulariiflora, genus Picrorhiza such as Picrorhiza Scrophulariiflora, genus Plantago such as Plantago asiatica, Plantago depressa, Plantago lagopus, Plantago lanceolata, Plantago major, Plantago maritima, Plantago media and Plantago palmate, genus Rehmannia such as Rehmannia glutinosa, genus Sanango such as Sanango racemosum, genus Veronica such as Veronica beccabunga, Veronica cheesemanii, Veronica fuhsii, Veronica hookeriana, Veronica teucrium and Veronica jacquinii, genus Wulfenia such as Wulfenia carinthiaca and genus Wulfeniopsis such as Wulfeniopsis amherstiana (Biringanine et al., Journal de la Societe Ouest-Africaine de Chimie (2007), 12(23): 35-40; Calis et al., Helvetica Chimica Acta (1991), 74(6): 1273-1277; Cervellati et al., Zeitschrift fuer Naturforschung, C: Journal of Biosciences (2004), 59(3/4): 255-262; Chen et al., Guangxi Zhiwu (2010), 30(2): 269-273; Davey et al., Phytochemistry (Elsevier) (2004), 65(15): 2197-2204; Deyama et al., Studies in Natural Products Chemistry (2006), 33(Bioactive Natural Products (Part M)): 645-674; Gonda et al., Electrophoresis (2013), 34(17): 2577-2584; Jensen et al., Biochemical Systematics and Ecology (2011), 39(3): 193-197; Jensen et al., Biochemical Systematics and Ecology (2009), 37(4): 421-425; Jensen, Phytochemistry (1996), 43(4): 777-783; Kirmizibekmez et al., Helvetica Chimica Acta (2009), 92(9): 1845-1852; Ma et al., Yunnan Zhiwu Yanjiu (1995), 17(1): 96-102; Maggi et al., Biochemical Systematics and Ecology (2009), 37(6): 731-736; Matsumoto et al., Phytochemistry (1987), 26(12): 3225-3227; Nakamura et al., Chemical & Pharmaceutical Bulletin (1997), 45(3): 499-504; Olennikov et al., Chemistry of Natural Compounds (2011), 47(2): 165-169; Oriola et al., African Journal of Traditional, Complementary and Alternative Medicines (2014), 11(2): 319-323; Ozipek et al., Chemical & Pharmaceutical Bulletin (1999), 47(4): 561-562; Ravn et al., Phytochemistry Letters (2015): 12, 42-53; Shoyama et al., Phytochemistry (1986), 25(7): 1633-1636; Velazquez Fiz M P et al., Zeitschrift fur Naturforschung. C, Journal of biosciences (2000), 55(11-12): 877-880; Wu et al., Rapid Communications in Mass Spectrometry (2016), 30(19): 2145-2154; Xiang et al., Phytotherapy Research (2017), 31(10): 1509-1520; Yang et al., Chemistry of Natural Compounds (2012), 48(4): 555-558; Zivkovic et al., Chemistry & Biodiversity (2017), 14(8); Zou et al., Molecules (2008), 13(9): 2049-2057; Zou et al., Molecules (2008), 13(9): 2049-2057). Plantamajoside has also been reported to possess anti-hypertensive, anti-neurodegenerative, antioxidant, anti-microbial and anti-proliferative activities and proposed to be applied in the treatment of atherosclerosis, diabetes, dermatosis, hair loss, skin photo-aging as well as kidney dysfunction, liver malfunction and prostate malfunction (CN 106176777 A; CN 106266019 A; CN 107115479 A; JP 08268844; KR 2012113837 A; KR 2012129370 A; KR 2012129371 A; Han et al., Photochemistry and Photobiology (2016), 92(5): 708-719; Li et al., RSC Advances (2015), 5(64): 51701-51707; Oriola et al., African Journal of Traditional, Complementary and Alternative Medicines (2014), 11(2): 319-323; Xiang et al., Phytotherapy Research (2017), 31(10): 1509-1520; Zivkovic et al., Chemistry & Biodiversity (2017), 14(8)).

2′-Acetylacteoside was identified in genus Aeginetia such as Aeginetia indica, genus Boschniakia such as Boschniakia himalaica, genus Brandisia such as Brandisia hancei, genus Callicarpa such as Callicarpa dichotoma Callicarpa kwangtungensis, Callicarpa maingayi and Callicarpa nudiflora, genus Cernua such as Cernua Loefling, genus Cistanche such as Cistanche deserticola, Cistanche Hoffing, Cistanche phelypaea, Cistanche salsa, Cistanche sinensis and Cistanche tubulosa, genus Harpagophytum such as Harpagophytum procumbens, genus Incarvillea such as Incarvillea younghusbandii, genus Marrubium such as Marrubium peregrinum, genus Orobanche such as Orobanche pycnostachya, Orobanche aegyptiaca and Orobanche ramosa, genus Pedicularis such as Pedicularis condensate and Pedicularis densispic, genus Rehmannia such as Rehmannia glutinosa, genus Rosa such as Rosa rugose, genus Sanango such as Sanango racemosum, genus Verbena such as Verbena littoralis and genus Verbascum such as Verbascum sinaiticum (Ado et al., South African Journal of Botany (2016), 104: 98-104; Afifi et al., Mansoura Journal of Pharmaceutical Sciences (1993), 9(2): 225-233; Cai et al., PLoS One (2014), 9(3), e93000/1-e93000/14, 14 pp; Chu et al., Zeitschrift fuer Naturforschung, B: A Journal of Chemical Sciences (2011), 66(6): 641-646; Clarkson et al., Journal of Natural Products (2006), 69(9): 1280-1288; Elgindi et al., Asian Journal of Chemistry (2000), 12(1): 127-130; Eribekyan et al., Khimiya Prirodnykh Soedinenii (1991), (5): 723-724; Fu et al., Journal of Pharmacy and Pharmacology (2006), 58(9): 1275-1280; Haid et al., Gastroenterology (2012), 143(1): 213-222.e5; He et al., Yunnan Zhiwu Yanjiu (1990), 12(4): 439-446; Ho et al., Journal of the Chinese Chemical Society (Taipei, Taiwan) (2004), 51(5A): 1073-1076; Jensen, Phytochemistry (1996), 43(4): 777-783; Kobayashi et al., Chemical & Pharmaceutical Bulletin (1984), 32(10): 3880-3885; Kobayashi et al., Chemical & Pharmaceutical Bulletin (1987), 35(8): 3309-3314; Koo et al., Planta Medica (2005), 71(8): 778-780; Lei et al., Zhongcaoyao (2003), 34(5): 473-476; Li et al., Yaowu Fenxi Zazhi (2016), 36(2): 291-295; Li et al., Chemical & Pharmaceutical Bulletin (2003), 51(9): 1103-1105; Qu et al., Biochemical Systematics and Ecology (2015), 60: 199-203; Sasaki et al., Phytochemistry (1989), 28(3): 875-879; Shi et al., Journal of Pharmaceutical and Biomedical Analysis (2013), 75: 239-247; Tu et al., Journal of Asian Natural Products Research (2007), 9(1): 79-84; Wan et al., Chinese Chemical Letters (2012), 23(5): 579-582; Wu et al., Zhongcaoyao (2012), 43(1): 55-59; Xiong et al., Wakan Iyakugaku Zasshi (1996), 13(4): 360-361; Xu et al., Zhongcaoyao (1994), 25(10): 509-513). 2′-Acetylacteoside has also been reported to exhibit antioxidative and anti-proliferative effect and possess anti-allergy, anti-inflammatory and anti-hepatotoxic activities. 2′-Acetylacteoside was therefore proposed to be used in the prevention of Arteriosclerosis hyperlipemia as well as the treatment of diabetic neuropathy, degenerative nerve diseases, radiation injury, skin disorders, scar tissue and leukemia (CN 101301298 A; JP 02040394 A; KR 2004064830 A; US 20030105031 A1; US 20030105027 A1; US 20060189543 A1; US 20060293257 A1; WO 2002049575 A2; He et al., Planta Medica (2001), 67(6): 520-522; Xiong et al., Planta Medica (1998), 64(2): 120-125; Xiong et al., Biological & Pharmaceutical Bulletin (1996), 19(12): 1580-1585).

Crassifolioside was identified in genus Euphrasia such as Euphrasia rostkoviana, genus Magnolia such as Magnolia officinalis and Magnolia salicifolia, genus Plantago such as Plantago crassifolia and genus Strobilanthus such as Strobilanthus callosus and Strobilanthus ixiocephala (Agarwa et al., Indian Drugs (2001), 38(12): 646-648; Aiello et al., Acta Horticulturae (2010), 860(Proceedings of the IVth International Symposium on Breeding Research on Medicinal and Aromatic Plants, 2009): 105-108; Andary et al., Phytochemistry (1988), Volume Date 1989, 28(1): 288-290; Porter et al., Phytochemistry Elsevier) (2015), 117: 185-193). Crassifolioside was reported to possess photoprotective property (Ge et al., RSC Advances (2018), 8(8): 4362-4371).

Ligurobustoside N was identified in genus Ligustrum such as Ligustrum purpurascens and Ligustrum robustum and reported to exhibit antioxidative activities (He et al., Journal of Natural Products (2003), 66(6): 851-854; She et al., Journal of Food Science (2008), 73(6): C476-C481).

Cistanoside C was identified in genus Aeginetia such as Aeginetia indica, genus Callicarpa such as Callicarpa kochiana, genus Cistanche such as Cistanche deserticola, Cistanche Hoffing and Cistanche salsa, genus Clerodendron such as Clerodendron bungei, genus Lamiophlomis such as Lamiophlomis rotata, genus Leonurus such as Leonurus japonicas and genus Pedicularis such as Pedicularis artselaeri, Pedicularis lasiophrys, Pedicularis longiflora, Pedicularis semitorta, Pedicularis torta and Pedicularis verticillata (Ho et al., Journal of the Chinese Chemical Society (Taipei, Taiwan) (2004), 51(5A): 1073-1076; Jia et al., Phytochemistry (1991), Volume Date 1992, 31(1): 263-266; Jia et al., Phytochemistry (1992), 31(9): 3125-3127; Kobayashi et al., Chemical & Pharmaceutical Bulletin (1984), 32(10): 3880-3885; Lei et al., Zhongcaoyao (2003), 34(5): 473-476; Li et al., Yaoxue Xuebao (2005), 40(8): 722-727; Li et al., Carbohydrate Research (2012), 348: 42-46; Lin et al., Zhongyao Xinyao Yu Linchuang Yaoli (2010), 21(3): 276-279, 284; Su et al., Planta Medica (1998), 64(8): 720-723; Su et al., Phytochemistry (1997), 45(6): 1271-1273; Wang et al., Indian Journal of Chemistry, Section B: Organic Chemistry Including Medicinal Chemistry (1997), 36B(2): 150-153; Wang et al., Phytochemistry (1997), 45(1): 159-166; Xu et al., Zhongcaoyao (1994), 25(10): 509-513; Yi et al., Phytochemistry (1999), 51(6): 825-828). Cistanoside C was reported to possess antioxidative and anti-hepatotoxic activities and proposed to be suitable for use in the prevention and/or treatment of degenerative diseases such as cancer and aging (Clayton et al., Australian Journal of Chemistry (2014), 67(10): 1461-1470; Shi et al., Biochimica et Biophysica Acta, General Subjects (1999), 1472(1-2): 115-127).

Isoplantamajoside was identified in genus Boschniakia such as Boschniakia himalaica, genus Chirita such as Chirita longgangensis, genus Digitalis such as Digitalis purpurea and Digitalis trojana, genus Hemiphragma such as Hemiphragma heterophyllum, genus Houttuynia such as Houttuynia cordata, genus Penstemon such as Penstemon linarioides, genus Plantago such as Plantago asiatica, Plantago depressa Willd, Plantago hostifolia, Plantago lanceolate and Plantago major and genus Picrorhiza such as Picrorhiza scrophulariiflora (Kirmizibekmez et al., Phytotherapy Research (2014), 28(4): 534-538; Ma et al., Yunnan Zhiwu Yanjiu (1995), 17(1): 96-102; Ma et al., Chemistry of Natural Compounds (2016), 52(4): 761-763; Miyase et al., Phytochemistry (1991), 30(6): 2015-2018; Nishibe et al., Foods & Food Ingredients Journal of Japan (1995), 166: 43-49; Sasahara et al., Shoyakugaku Zasshi (1992), 46(3): 268-272; Wang et al., Zhongguo Zhongyao Zazhi (2005), 30(24): 1921-1923; Wang et al., Chemical & Pharmaceutical Bulletin (2004), 52(5): 615-617; Yang et al., Chemistry of Natural Compounds (2012), 48(4): 555-558; Zhou et al., Journal of Natural Products (1998), 61(11): 1410-1412). Isoplantamajoside was reported to show hypotensive, diuretic and hypoglycemic effect and further anti-inflammatory, cellular antioxidant and radical scavenging, hepatoprotective and anti-proliferative activities, and was therefore proposed to be suitable for use in the prevention of skin photoaging (Kim et al., Bulletin of the Korean Chemical Society (2015), 36(2): 659-664; Kirmizibekmez et al., Phytotherapy Research (2014), 28(4): 534-538; Ma et al., Chemistry of Natural Compounds (2016), 52(4): 761-763; Qi et al., Journal of Separation Science (2012), 35(12): 1470-1478; Zhou et al., Journal of Agricultural and Food Chemistry (2013), 61(27): 6693-6702).

Forsythoside and its isomers such as isoforsythoside and isoforsythiaside were identified in genus Forsythia such as Forsythia suspense, genus Morus, genus Chrysanthemum and genus Nicandra such as Nicandra physaloides (Pan et al., Zhongcaoyao (2016), 47(8): 1289-1296; Qu et al., Bioorganic Chemistry (2012), 40: 87-91; Wang et al., Molecules (2009), 14(3): 1324-1331; Yang et al., Natural Product Research (2017), 31(22): 2634-2640), and were reported to possess antioxidant, anti-inflammatory and antibacterial activities (Pan et al., Zhongcaoyao (2016), 47(8): 1289-1296; Qu et al., Bioorganic Chemistry (2012), 40: 87-91; Yang et al., Natural Product Research (2017), 31(22): 2634-2640; Zhou et al., Phytomedicine (2014), 21(12): 1549-1558).

Accordingly, the present invention provides a method of using a polyphenol compound such as verbascoside, isoverbascoside, ligupurpuroside A, plantamajoside, 2′-acetylacteoside, crassifolioside, ligurobustoside N, cistanoside C, isoplantamajoside, forsythoside, isoforsythoside, Isoforsythiaside, a salt thereof or a mixture thereof to enhance the sweetness, mask the bitter off-taste and/or improve the flavor perception of a sweetness modifier and decrease the amount of a sweetness modifier used in a consumable.

The term “a polyphenol compound” is understood to mean a compound represented by Formula B provided above such as verbascoside, isoverbascoside, ligupurpuroside A, plantamajoside, 2′-acetylacteoside, crassifolioside, ligurobustoside N, cistanoside C, isoplantamajoside, forsythoside, isoforsythoside. Isoforsythiaside, a salt thereof or a mixture thereof.

Further, the polyphenol compound of the present invention has also been found to possess an unexpected and advantageous use in food. In particular, the polyphenol compound of the present invention has been found to enhance the sweetness, mask the bitter off-taste and/or improve the flavor perception of sweetness modifiers without undesirable off-notes. The term “a polyphenol compound” is understood to mean one or more of the polyphenol compound as described herein.

In the present invention, verbascoside and isoverbascoside are available commercially and can also be an isolated and purified form a botanical extract, for example, genus Campsis such as Campsis grandiflora and Campsis radicans, genus Conandron such as Conandron minor, Conandron ramondioides and Conandron rhynchotechioides, genus Ligustrum such as Ligustrum amamianum, Ligustrum amurense, Ligustrum angustum, Ligustrum australianum, Ligustrum chenaultii, Ligustrum compactum, Ligustrum confusum, Ligustrum delavayanum, Ligustrum expansum, Ligustrum gracile, Ligustrum henryi, Ligustrum ibota, Ligustrum indicum, Ligustrum japonicum, Ligustrum leucanthum, Ligustrum lianum, Ligustrum liukiuense, Ligustrum longitubum, Ligustrum lucidum, Ligustrum massalongianum, Ligustrum micranthum, Ligustrum microcarpum, Ligustrum morrisonense, Ligustrum obovatilimbum, Ligustrum obtusifolium, Ligustrum ovalifolium, Ligustrum pedunculare, Ligustrum pricei, Ligustrum punctifolium, Ligustrum quihoui, Ligustrum retusum, Ligustrum robustum, Ligustrum sempervirens, Ligustrum sinense, Ligustrum strongylophyllum, Ligustrum tenuipes, Ligustrum tschonoskii, Ligustrum vulgare, Ligustrum xingrenense and Ligustrum yunguiense, genus Lippia such as Lippia abyssinica, Lippia alba, Lippia balansae, Lippia carterae, Lippia dulcis, Lippia durangensis, Lippia graveolens, Lippia javanica, Lippia kituiensis, Lippia lasiocalycina, Lippia lupulina, Lippia micromera, Lippia multiflora, Lippia myriocephala, Lippia palmeri, Lippia pretoriensis, Lippia rehmannii, Lippia salicifolia, Lippia salviaefolia, Lippia scaberrima, Lippia sidoides, Lippia substrigosa, Lippia thymoides and Lippia velutina, genus Olea such as europaea, genus Osmanthus such as Osmanthus americanus, Osmanthus armatus, zOsmanthus attenuatus, Osmanthus austrocaledonicus, Osmanthus cooperi, Osmanthus cymosus, Osmanthus decorus, Osmanthus delavayi, Osmanthus didymopetalus, Osmanthus enervius, Osmanthus fordii, Osmanthus fragrans, Osmanthus gracilinervis, Osmanthus hainanensis, Osmanthus Osmanthus heterophyllus, Osmanthus insularis, Osmanthus iriomotensis, Osmanthus kaoi, Osmanthus lanceolatus, Osmanthus marginatus, Osmanthus matsumuranus, Osmanthus mexicanus, Osmanthus minor, Osmanthus monticola, Osmanthus pubipedicellatus, Osmanthus reticulatus, Osmanthus rigidus, Osmanthus scortechinii, Osmanthus serrulatus, Osmanthus suavis, Osmanthus sumatranus, Osmanthus urceolatus, Osmanthus venosus and Osmanthus yunnanensis, genus Phyla such as Phyla canescens, Phyla chinensis, Phyla cuneifolia, Phyla dulcis, Phyla fruticosa, Phyla lanceolata, Phyla nodiflora and Phyla stoechadifolia, and genus Chaenomeles such as Chaenomeles cathayensis, Chaenomeles japonica and Chaenomeles speciose.

If provided as a botanical extract, preferably the extract is enriched for a secoiridoid glucoside or a polyphenol compound to achieve a content of about 0.01% and greater, respectively. For example, the botanical extract contains a secoiridoid glucoside or a polyphenol compound from about 0.05% to about 95%, from about 0.1% to about 50% or from about 0.2% to about 10%. Unless otherwise specified, percentages (% s) are by weight.

A natural sweetener includes, for example, but not limited to, sucrose, fructose, glucose, high fructose corn syrup, Stevia rebaudiana compositions including pure components of Reb A, stevioside, and rebaudioside D (Reb D), xylose, arabinose, or rhamnose, as well as sugar alcohols such as erythritol, xylitol, mannitol, sorbitol, inositol and a combination thereof. An artificial sweetener includes, for example, but not limited to, aspartame, sucralose, neotame, acesulfame potassium, saccharin and a combination thereof.

A flavoring is a preparation that provides a consumable with a particular taste and/or smell. A flavoring with modifying properties is a subset of the flavoring. It is added to the consumable to reduce off-notes and/or improve overall profile. The flavorings with modifying properties of the present invention include, for example, but not limited to, a stevia composition including stevioside, steviolbioside Reb A, rebaudioside B (Reb B), rebaudioside C (Reb C), Reb D, rebaudioside E (Reb E), rebaudioside F (Reb F), dulcoside A, dulcoside B, rubusoside, alpha-glucosyl stevia, fructosyl stevia, galactosyl stevia, beta-glucosyl stevia, siamenoside, mogrosidc IV, mogroside V, Luo Han Guo, monatin, glycyrrhizic acid, thaumatin, a salt thereof, a glycosylated derivative thereof and a combination thereof. The glycosylated derivatives can be prepared via transglycosylation reactions with, for example, but not limited to, glucose, fructose, galactose, rhamnose, ribose, mannose, arabinose, fucose, maltose, lactose, sucrose, rutinose, sorbose, xylulose, ribulose, rhammulose and xylose. In one embodiment, the flavorings with modifying properties of the present invention include Reb A, Reb C, rubusoside, Reb D, mogroside V, Luo Han Guo, monatin acid, a salt thereof, a glycosylated derivative thereof and a combination thereof. The flavorings with modifying properties of the present invention exhibit weak intrinsic sweetness. Some other flavorings of the present invention include, for example, but not limited to, curculin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, cyclocarioside I and a combination thereof.

Accordingly, the term “a sweetness modifier” of the present invention refers to a sweetener including a natural sweetener and an artificial sweetener or a flavoring with modifying properties set forth in the above.

The term “sweetness” or “sweetness intensity” is understood to mean the relative strength of sweet sensation as observed or experienced by an individual, e.g., a human, or a degree or amount of sweetness detected by a taster, for example on the scale from 0 (none) to 8 (very strong) used in sensory evaluations according to the procedure described in American Society for Testing Materials, Special Technical Publication-434: “Manual on Sensory Testing Methods,”ASTM International, West Conshohocken, Pa. (1996).

The term “olfactory effective amount” is understood to mean the amount of a secoiridoid glucoside or a polyphenol compound as described herein used in a combination with a sweetness modifier, wherein the secoiridoid glucoside or the polyphenol compound enhances the sweetness, masks the bitter off-taste and/or improves the flavor perception of the sweetness modifier. Its olfactory effective amount may vary depending on many factors including other ingredients, their relative amounts and the olfactory effect that is desired. Any amount of a secoiridoid glucoside or a polyphenol compound that provides the desired degree of sweetness enhancement, bitter off-taste masking and/or flavor perception improvement without exhibiting off-taste can be used. In certain embodiments, the olfactory effective amount ranges from about 1 ppb to about 1000 ppm by weight, preferably from about 5 ppb to about 100 ppm by weight and more preferably from about 10 ppb to about 10 ppm by weight. When used in the form of a botanical extract, the olfactory effective amount ranges from about 100 ppb to about 1000 ppm by weight, preferably from about 1 to about 500 ppm by weight and more preferably from about 5 to about 200 ppm.

A consumable includes, for example, a food product (e.g., a beverage), a sweetener such as a natural sweetener or an artificial sweetener, a pharmaceutical composition, a dietary supplement, a nutraceutical, a dental hygienic composition and a cosmetic product. The consumable may further contain a flavoring.

In some embodiments, a consumable is a food product including, for example, but not limited to, fruits, vegetables, juices, meat products such as ham, bacon and sausage, egg products, fruit concentrates, gelatins and gelatin-like products such as jams, jellies, preserves and the like, milk products such as yogurt, ice cream, sour cream and sherbet, icings, syrups including molasses, corn, wheat, rye, soybean, oat, rice and barley products, nut meats and nut products, cakes, cookies, confectionaries such as candies, gums, fruit flavored drops, and chocolates, chewing gums, mints, creams, pies and breads. In a certain embodiment, the food product is a beverage including, for example, but not limited to, coffee, tea, carbonated soft drinks, such as COKE and PEPSI, non-carbonated soft drinks and other fruit drinks, sports drinks such as GATORADE and alcoholic beverages such as beers, wines and liquors. A consumable also includes prepared packaged products, such as granulated flavor mixes, which upon reconstitution with water provide non-carbonated drinks, instant pudding mixes, instant coffee and tea, coffee whiteners, malted milk mixes, pet foods, livestock feed, tobacco, and materials for baking applications, such as powdered baking mixes for the preparation of breads, cookies, cakes, pancakes, donuts and the like. A consumable also includes diet or low-calorie food and beverages containing little or no sucrose. A preferred consumable includes carbonated beverages. Consumables further include condiments such as herbs, spices and seasonings, flavor enhancers (e.g., monosodium glutamate), dietetic sweeteners and liquid sweeteners.

In other embodiments, a consumable is a pharmaceutical composition, a dietary supplement, a nutraceutical, a dental hygienic composition or a cosmetic product. Preferred compositions are pharmaceutical compositions containing a secoiridoid glucoside or a polyphenol compound, one or more pharmaceutically acceptable excipients, and one or more active agents that exert a biological effect other than sweetness enhancement. Such active agents include pharmaceutical and biological agents that have an activity other than taste enhancement. Such active agents are well known in the art (See, e.g., The Physician's Desk Reference). Such compositions can be prepared according to procedures known in the art, for example, as described in Remington's Pharmaceutical Sciences, Mack Publishing Co., Easton, Pa. In one embodiment, such an active agent includes a bronchodilator, an anorexiant, an antihistamine, a nutritional supplement, a laxative, an analgesic, an anesthetic, an antacid, a H2-receptor antagonist, an anticholinergic, an antidiarrheal, a demulcent, an antitussive, an antinauseant, an antimicrobial, an antibacterial, an antifungal, an antiviral, an expectorant, an anti-inflammatory agent, an antipyretic and a mixture thereof. In another embodiment, the active agent is selected from the group consisting of an antipyretic and analgesic, e.g., ibuprofen, acetaminophen or aspirin, a laxative, e.g., phenolphthalein dioctyl sodium sulfosuccinate, an appetite depressant, e.g., an amphetamine, phenylpropanolamine, phenylpropanolamine hydrochloride, or caffeine, an antacid, e.g., calcium carbonate, an antiasthmatic, e.g., theophylline, an antidiarrheal, e.g., diphenoxylate hydrochloride, an agent against flatulence, e.g., simethecon, a migraine agent, e.g., ergotamine tartrate, a psychopharmacological agent, e.g., haloperidol, a spasmolytic or sedative, e.g., phenobarbital, an antihyperkinetic, e.g., methyldopa or methylphenidate, a tranquilizer, e.g., a benzodiazepine, hydroxyzine, meprobramate or phenothiazine, an antihistaminic, e.g., astemizol, chlorpheniramine maleate, pyridamine maleate, doxlamine succinate, brompheniramine maleate, phenyltoloxamine citrate, chlorcyclizine hydrochloride, pheniramine maleate, or phenindamine tartrate, a decongestant, e.g., phenylpropanolamine hydrochloride, phenylephrine hydrochloride, pseudoephedrine hydrochloride, pseudoephedrine sulfate, phenylpropanolamine bitartrate, or ephedrine, a beta-receptor blocker, e.g., propranolol, an agent for alcohol withdrawal, e.g., disulfuram, an antitussive, e.g., benzocaine, dextromethorphan, dextromethorphan hydrobromide, noscapine, carbetapentane citrate, and chlophedianol hydrochloride, a fluorine supplement, e.g., sodium fluoride, a local antibiotic, e.g., tetracycline or clindamycin, a corticosteroid supplement, e.g., prednisone or prednisolone; an agent against gout, e.g., colchicine or allopurinol, an antiepileptic, e.g., phenytoin sodium, an agent against dehydration, e.g., electrolyte supplements, an antiseptic, e.g., cetylpyridinium chloride, a NSAID, e.g., acetaminophen, ibuprofen, naproxen, or a salt thereof, a gastrointestinal active agent, e.g., loperamide and famotidine, an alkaloid, e.g., codeine phosphate, codeine sulfate, or morphine, a supplement for trace elements, e.g., sodium chloride, zinc chloride, calcium carbonate, magnesium oxide, and other alkali metal salts and alkali earth metal salts; a vitamin, an ion-exchange resin, e.g., cholestyramine, a cholesterol-depressant and lipid-lowering substance, an antiarrhythmic, e.g., N-acetylprocainamide and an expectorant, e.g., guaifenesin. Examples of dietary supplements or nutraceuticals include, for example, but are not limited to, an enteral nutrition product for treatment of nutritional deficit, trauma, surgery, Crohn's disease, renal disease, hypertension, obesity and the like, to promote athletic performance, muscle enhancement or general well-being or inborn errors of metabolism such as phenylketonuria. In particular, such compositions can contain one or more amino acids which have a bitter or metallic taste or aftertaste. Such amino acids include, for example, but are not limited to, an essential amino acid such as L isomers of leucine, isoleucine, histidine, lysine, methionine, phenylalanine, threonine, tryptophan, tyrosine and valine. Dental hygienic compositions are known in the art and include, for example, but not limited to, a toothpaste, a mouthwash, a plaque rinse, a dental floss, a dental pain reliever (such as ANBESOL) and the like. In one embodiment, the dental hygienic composition includes one natural sweetener. In another embodiment, the dental hygienic composition includes more than one natural sweetener. In yet another embodiment, the dental hygienic composition includes sucrose and corn syrup, or sucrose and aspartame. A cosmetic product includes, for example, but not limited to, a face cream, a lipstick, a lip gloss and the like. Other suitable cosmetic products of use in this invention include a lip balm, such as CHAPSTICK or BURT'S BEESWAX Lip Balm.

In addition, the present invention also provides methods for enhancing the sweetness, masking the bitter off-taste and/or improving the flavor perception of a flavoring with modifying properties and decreasing its use level in a consumable by incorporating a secoiridoid glucoside or a polyphenol compound. In one embodiment, the invention provides a consumable containing an olfactory effective amount of a secoiridoid glucoside or a polyphenol compound and a flavoring with modifying properties in a reduced amount in order to achieve the same level of sweetness when the flavoring with modifying properties is used alone in a traditional amount. In this respect, the amount of flavoring with modifying properties used in a consumable can be reduced by at least about 10%, 20%, 30%, 40%, 50%, 60%, 70%, 80%, 90%, or 95%, from about 60% to about 99% or from about 20% to about 50%.

As indicated, a secoiridoid glucoside or a polyphenol compound can be used in a consumable as a sweetness enhancer, a bitter off-taste masker and/or a flavor perception modifier, which retains a desired sweetness but contains lower amounts of a natural sweetener or an artificial sweetener. For example, an improved carbonated soft drink can be produced with the same sweetness as the known carbonated soft drink but with lower sugar content by adding ligustrosidic acid or a derivative thereof.

Additional materials can also be used in conjunction with a secoiridoid glucoside or a polyphenol compound of the present invention to encapsulate and/or deliver the lingering aftertaste masking effect. Some well-known materials are, for example, but not limited to, polymers, oligomers, other non-polymers such as surfactants, emulsifiers, lipids including fats, waxes and phospholipids, organic oils, mineral oils, petrolatum, natural oils, perfume fixatives, fibers, starches, sugars and solid surface materials such as zeolite and silica. Some preferred polymers include polyacrylate, polyurea, polyurethane, polyacrylamide, polyester, polyether, polyamide, poly(acrylate-co-acrylamide), starch, silica, gelatin and gum Arabic, alginate, chitosan, polylactide, poly(melamine-formaldehyde), poly(urea-formaldehyde), or a combination thereof.

The term “alkyl” means a linear or branched saturated monovalent hydrocarbon, e.g., methyl, ethyl, propyl, 2-propyl, butyl (including all isomeric forms), pentyl (including all isomeric forms), hexyl (including all isomeric forms), and the like. The term “alkenyl” means a linear or branched unsaturated, aliphatic hydrocarbon containing at least one carbon-carbon double bond. The term “aryl” means a carbon-based aromatic group including, but not limited to, benzene, phenyl, and the like. The term “alkylene” refers to bivalent alkyl. Examples include —CH₂—, —CH₂CH₂—, —CH₂CH₂CH₂—, —CH₂(CH₃)CH₂—, —CH₂CH₂CH₂CH₂—, and the like.

The following are provided as specific embodiments of the present invention. Other modifications of this invention will be readily apparent to those skilled in the art. Such modifications are understood to be within the scope of this invention. Materials were purchased from Aldrich Chemical Company unless noted otherwise. As used herein all percentages are weight percent unless otherwise noted, ppm is understood to stand for parts per million, L is understood to be liter, mL is understood to be milliliter, g is understood to be gram, Kg is understood to be kilogram, mol is understood to be mole, mmol is understood to be millimole, psig is understood to be pound-force per square inch gauge, and mmHg be millimeters (mm) of mercury (Hg). IFF as used in the examples is understood to mean International Flavors & Fragrances Inc., New York, N.Y., USA.

### Example I: Preparation of Test Samples

Chaenomeles speciosa leave extract was purchased (AuNutra® Industries Inc., California, U.S.). Among different batches, ligustrosidic acid, 2′-hydroxy ligustrosidic acid, verbascoside and isoverbascoside were identified, ranging from ˜0.1-1%, from ˜0.2-2%, from ˜0.2-2% and from ˜0.01-0.4%, respectively. Further fractionation was performed using high performance liquid chromatography (HPLC) to provide ligustrosidic acid at ˜95% purity.

In addition, individual compounds including 2′-hydroxy ligustrosidic acid, verbascoside (Indofine Chemical Company, Inc., New Jersey, U.S.) and isoverbascoside (MedChemExpress, New Jersey, U.S.) were purchased.

### Example II: Enhancement of Sucrose Sweetness

A sucrose solution (4%) was prepared in water. Each of ligustrosidic acid and 2′-hydroxy ligustrosidic acid solutions of different concentrations was prepared in ethanol solution in water (50%). Ligustrosidic acid and 2′-hydroxy ligustrosidic acid were evaluated at 1 and 200 ppm, respectively. Both were devoid of taste and smell.

The flavor profile of the sucrose solution with added ligustrosidic acid and 2′-hydroxy ligustrosidic acid is reported in the following:

| | Compound | | | | | |
|---|---|---|---|---|---|---|
| | Ligustrosidic Acid (ppm) | | | 2′-Hydroxy Ligustrosidic Acid (ppm) | | |
| Concentration (ppm) | 0.155 | 0.310 | 0.620 | 0.160 | 0.320 | 0.640 |
| Flavor Profile | Enhanced | Strong, | Enhanced | Slightly | Upfront | Enhanced |
| | sweetness | sucrose | flavor but | enhanced | and lasting | flavor but |
| | and | syrup-like | impact | sweetness | sweetness, | impact |
| | mouthfeel, | sweetness, | started to | without | pleasant | started to |
| | fuller body | much fuller | level off | much | | level off |
| | with | body with | | impact on | | |
| | increased | glycerin-like | | mouthfeel | | |
| | viscosity | heaviness | | | | |

Ligustrosidic acid exhibited particularly strong effect. When used with sucrose, ligustrosidic acid enhanced overall sweetness, body and mouthfeel. 2′-Hydroxy ligustrosidic acid exhibited strong effect in sweetness enhancement.

### Example III: Enhancement of Luo Han Guo Sweetness

A Luo Han Guo (Biovittoria Ltd., New Zealand) solution was prepared in water (120 ppm). Ligustrosidic acid and 2′-hydroxy ligustrosidic acid solutions were prepared as above (EXAMPLE II). The flavor profile of the Luo Han Guo solution with added ligustrosidic acid and 2′-hydroxy ligustrosidic acid is reported in the following:

| | Compound | | | | | |
|---|---|---|---|---|---|---|
| | Ligustrosidic Acid (ppm) | | | 2′-Hydroxy Ligustrosidic Acid (ppm) | | |
| Concentration (ppm) | 0.155 | 0.310 | 0.620 | 0.160 | 0.320 | 0.640 |
| Flavor Profile | More | Significantly | Very heavy | Slightly | Sugar-like | Increased |
| | sugar-like | increased | and syrup- | enhanced | sweetness | sweetness |
| | and less | body fullness, | like profile, | sweetness | without | |
| | licorice-like | upfront | less off- | without | much | |
| | sweetness, | sweetness, | taste, an | much | impact on | |
| | upfront | more sugar- | undesirable | impact on | mouthfeel | |
| | mouthfeel, | like and less | suppression | mouthfeel, | | |
| | fuller body | licorice-like, | of sweetness | licorice-like | | |
| | | less tingling | appeared | sweetness | | |
| | | off-taste | | remained | | |

Ligustrosidic acid exhibited particularly strong effect. When used with Luo Han Guo, ligustrosidic acid enhanced overall sweetness, body and mouthfeel. 2′-Hydroxy ligustrosidic acid exhibited strong effect in sweetness enhancement.

### Example IV: Preparation of Test Solutions

The effect of botanical extract such as Chaenomeles speciosa leave extract on sweetness was examined. Solutions of Chaenomeles speciosa leave extract containing ligustrosidic acid (0.61%), 2′-hydroxy ligustrosidic acid (0.62%), verbascoside (0.69%) and isoverbascoside (0.21%) were prepared in ethanol solution in water (50%) to obtain a series of concentrations ranging from 1 to 1000 ppm.

Solutions of sucrose (4%) and Luo Han Guo (120 ppm) were prepared as above (EXAMPLE II and III). In addition, solutions of fructose (3.4%), Reb A (GLG Life Tech Corporation, Canada) (90 ppm) and GSG (Glucosyl Steviol Glucosides, GLG Life Tech Corporation, Canada) (200 ppm) were also prepared in water.

The sweetness enhancement of (i) sucrose, (ii) Luo Han Guo, (iii) fructose, (iv) Reb A and (v) GSG by Chaenomeles speciosa leave extract was evaluated, respectively. In all groups tested, Chaenomeles speciosa leave extract enhanced sweetness.

### Example V: Enhancement of Sucrose Sweetness by Botanical Extract

The sucrose solution (4%) with the addition of various amount of Chaenomeles speciosa leave extract was evaluated. The flavor profile is as follows:

| Sample | Extract (ppm) | Flavor Profile |
|---|---|---|
| 1 | 0 (Base) | Mild in sweet perception |
| 2 | 1 | Very slight effect, started to display the perception of sugary syrup, |
| | | slightly botanical, slightly enhanced mouthfeel |
| 3 | 10 | Natural fruit juice-like |
| 4 | 20 | Caramelized sugar-like, viscous mouthfeel |
| 5 | 50 | Long lasting and enhanced sweetness, pleasant sugary mouthfeel, |
| | | sugar distillate-like |
| 6 | 100 | Maple syrup-like, brown and cooked sugar-like, mouth coating |
| 7 | 200 | More botanical and fruity sweetness, started to display off-taste and |
| | | astringent note |
| 8 | 500 | More off-taste and astringent note started to overpower sweetness |
| 9 | 1000 | Woody, barky and astringent notes overpowered sweetness |

Chaenomeles speciosa leave extract enhanced sucrose mouthfeel starting at 1 ppm and sucrose sweetness at 10 ppm. However, undesirable off-taste started to develop at 500 ppm.

### Example VI: Enhancement of Fructose Sweetness by Botanical Extract

The fructose solution (3.4%) with the addition of various amount of Chaenomeles speciosa leave extract was evaluated. The flavor profile is as follows:

| Sample | Extract (ppm) | Flavor Profile |
|---|---|---|
| 1 | 0 (Base) | Mild in sweet perception |
| 2 | 1 | Slightly enhanced mouthfeel, slightly more mouth coating |
| 3 | 10 | More fruity, added body |
| 4 | 20 | Started to become sucrose-like, more body, more fullness |
| 5 | 50 | More sucrose-like, viscous, more mouth coating |
| 6 | 100 | Maple syrup-like, more mouth coating |
| 7 | 200 | Started to display off-taste and astringent note |
| 8 | 500 | More off-taste and astringent note started to overpower sweetness |
| 9 | 1000 | Woody, barky and astringent notes overpowered sweetness |

Chaenomeles speciosa leave extract provided sucrose-like flavor profile. Chaenomeles speciosa leave extract enhanced fructose sweetness, body and mouthfeel at all levels tested. However, undesirable off-taste started to develop at 500 ppm.

### Example VII: Enhancement of Luo Han Guo Sweetness by Botanical Extract

The Luo Han Guo solution (120 ppm) with the addition of various amount of Chaenomeles speciosa leave extract was evaluated. The flavor profile is as follows:

| Sample | Extract (ppm) | Flavor Profile |
|---|---|---|
| 1 | 0 (Base) | Mild in sweet perception |
| 2 | 1 | Some mouthfeel |
| 3 | 10 | Earlier onset sweetness, persistent mouthfeel helped to suppress |
| | | bitterness |
| 4 | 20 | Upfront sweetness, upfront mouthfeel |
| 5 | 50 | Pleasant sweetness, less lingering bitterness, mouthfeel helped to |
| | | suppress off-taste |
| 6 | 100 | Clear effect, more sucrose-like, less off-taste |
| 7 | 200 | Started to display off-taste |
| 8 | 500 | More off-taste started to overpower sweetness |
| 9 | 1000 | Woody, barky and astringent notes overpowered sweetness |

Chaenomeles speciosa leave extract provided sucrose-like flavor profile. Chaenomeles speciosa leave extract enhanced Luo Han Guo sweetness and masked lingering bitterness. However, undesirable off-taste started to develop at 500 ppm.

### Example VIII: Enhancement of Reb A Sweetness by Botanical Extract

The Reb A solution (90 ppm) with the addition of various amount of Chaenomeles speciosa leave extract was evaluated. The flavor profile is as follows:

| Sample | Extract (ppm) | Flavor Profile |
|---|---|---|
| 1 | 0 (Base) | Mild in sweet perception |
| 2 | 1 | Very slight effect |
| 3 | 10 | Slightly earlier onset of sweet perception, slightly increased |
| | | mouthfeel, more body, less peakiness |
| 4 | 20 | Clear effect, enhanced sugary mouthfeel, more body, less lingering |
| | | bitterness, less stevia’s off-taste |
| 5 | 50 | Fruity sweetness, apple juice-like, enhanced mouthfeel |
| 6 | 100 | Sucrose-like, even more mouth fullness, pleasant mouth coating |
| 7 | 200 | Started to display off-taste |
| 8 | 500 | Woody and barky, still less stevia’s off-taste, maple syrup-like |
| 9 | 1000 | Woody and barky, still less stevia’s off-taste, maple syrup-like |

Chaenomeles speciosa leave extract enhanced Reb A sweetness and mouthfeel, and masked lingering bitterness and off-taste. However, undesirable off-taste started to develop at 500 ppm.

### Example IX: Enhancement of GSG Sweetness by Botanical Extract

The GSG (Glucosyl Steviol Glucosides) solution (200 ppm) with the addition of various amount of Chaenomeles speciosa leave extract was evaluated. The flavor profile is as follows:

| Sample | Extract (ppm) | Flavor Profile |
|---|---|---|
| 1 | 0 (Base) | Mild in sweet perception |
| 2 | 1 | Minimal effect |
| 3 | 10 | Very slight effect on sweetness, more mouthfeel |
| 4 | 20 | Very slight effect on sweetness, more mouthfeel |
| 5 | 50 | More sweetness, clearly enhanced mouthfeel |
| 6 | 100 | Enhanced sweetness and mouthfeel |
| 7 | 200 | Maple syrup-like with sugary mouthfeel, started to display |
| | | astringent note |
| 8 | 500 | Maple syrup-like, astringent |
| 9 | 1000 | Woody and barky |

Chaenomeles speciosa leave extract enhanced glucosyl steviol glucosides sweetness and mouthfeel. However, undesirable off-taste started to develop at 500 ppm.

### Example X: Sweetness Enhancement of Sucrose-Containing Yogurt

A Dannon Non-Fat Plain Yogurt with 6% sucrose was prepared and used as the base. Different amount of Chaenomeles speciosa leave extract was added to the base. Flavor profile was evaluated and is as follows:

| Sample | Extract (ppm) | Flavor Profile |
|---|---|---|
| 1 | 0 (Base) | Mild in sweet perception |
| 2 | 1 | Slightly more and lingering sweetness, less sour perception |
| 3 | 10 | More sweetness |
| 4 | 20 | Upfront sweetness, jammy, creamy, mouthwatering and pleasant, |
| | | waxy and cardboard-like notes decreased |
| 5 | 50 | Cooked sugar-like |
| 6 | 100 | Sweet, mouth coating and thick, less sourness |
| 7 | 200 | Intense sweetness, viscous, slight brown sugar note developed |
| 8 | 500 | Maple syrup-like, woody |
| 9 | 1000 | Woody and barky, more brown sugar note developed |

Chaenomeles speciosa leave extract enhanced the sweetness of sucrose-containing yogurt and reduced its sourness. However, undesirable off-taste started to develop at 1000 ppm.

### Example XI: Sweetness Enhancement of GSG-Containing Yogurt

A Dannon Plain Nonfat Yogurt with GSG (600 pm) was prepared and used as the base. Different amount of Chaenomeles speciosa leave extract was added to the base. Flavor profile was evaluated and is as follows:

| Sample | Extract (ppm) | Flavor Profile |
|---|---|---|
| 1 | 0 (Base) | Mild in sweet perception |
| 2 | 1 | Less sour perception |
| 3 | 10 | Slightly enhanced mouthfeel, less sourness and less |
| | | steviol’s off-taste |
| 4 | 20 | Enhanced upfront sweetness, rounded flavor profile |
| 5 | 50 | Enhanced upfront sweetness, mouthwatering, less steviol’s |
| | | off-taste, pleasant |
| 6 | 100 | Less steviol’s off-taste |
| 7 | 200 | Slight brown sugar note developed, cooked sugar-like |
| 8 | 500 | Maple syrup-like |
| 9 | 1000 | Woody and barky |

Chaenomeles speciosa leave extract enhanced the sweetness and mouthfeel of GSG-containing yogurt.

### Example XII: Sweetness Enhancement of Cane Sugar-Containing Yogurt

Different amount of Chaenomeles speciosa leave extract was added to Dannon Danimals Smoothies Yogurt Drink (Strawberry Explosion), which contained 9% cane sugar. Flavor profile was evaluated and is as follows:

| Sample | Extract (ppm) | Flavor Profile |
|---|---|---|
| 1 | 0 (Base) | Mild in sweet perception |
| 2 | 1 | Intense sweetness and mouthfeel, creamier |
| 3 | 10 | More sweetness, more natural strawberry flavor, creamier, more fat |
| | | perception, less plastic-like note |
| 4 | 20 | More and lingering sweetness, creamier, more fat perception |
| 5 | 50 | Significant mouth coating, more fat perception |
| 6 | 100 | Upfront sweetness |
| 7 | 200 | More overall sweetness, pleasant with no off-taste of the extract |
| 8 | 500 | Maple syrup-like sweetness |
| 9 | 1000 | Brown sugar-like, barky note overpowered the base flavor |

Chaenomeles speciosa leave extract enhanced the sweetness and mouthfeel of cane sugar-containing yogurt at all levels tested.

### Example XIII: Enhancement of Sucrose Sweetness

A sucrose solution (4%) was prepared in water. Each of verbascoside and isoverbascoside solutions of different concentrations was prepared in ethanol solution in water (50%). Verbascoside and isoverbascoside were evaluated at 1 and 200 ppm, respectively. Both were devoid of taste and smell.

The flavor profile of the sucrose solution with added verbascoside and isoverbascoside is reported in the following:

| | Compound | | | | | |
|---|---|---|---|---|---|---|
| | Verbascoside (ppm) | | | Isoverbascoside (ppm) | | |
| Concentration (ppm) | 0.175 | 0.350 | 0.700 | 0.053 | 0.105 | 0.210 |
| Flavor Profile | Slightly | Slightly | Slightly | Slight | Enhanced | More |
| | enhanced | enhanced | enhanced | enhanced | mouthfeel | sweetness |
| | sweetness | sweetness | sweetness | sweetness | | and more |
| | | | | and | | mouthfeel |
| | | | | mouthfeel | | |

Isoverbascoside enhanced overall mouthfeel. Verbascoside exhibited particular effect in sweetness enhancement.

### Example XIV: Enhancement of Luo Han Guo Sweetness

A Luo Han Guo (Biovittoria Ltd., New Zealand) solution was prepared in water (120 ppm). Verbascoside and isoverbascoside solutions were prepared as above (EXAMPLE XIII). The flavor profile of the Luo Han Guo solution with added verbascoside and isoverbascoside is reported in the following:

| | Compound | | | | | |
|---|---|---|---|---|---|---|
| | Verbascoside (ppm) | | | Isoverbascoside (ppm) | | |
| Concentration (ppm) | 0.175 | 0.350 | 0.700 | 0.053 | 0.105 | 0.210 |
| Flavor Profile | Minimal | Enhanced | Slightly | Enhanced | Enhanced | Enhanced |
| | effect, not | sweetness, | enhanced | heaviness | mouthfeel, | mouthfeel, |
| | much | did not mask | sweetness | and | masked off- | heavy, |
| | enhanced | off-taste | | viscosity, | taste | viscous, |
| | sweetness | | | not much | | masked off- |
| | | | | enhanced | | taste |
| | | | | sweetness | | |

Isoverbascoside enhanced overall mouthfeel and suppressed Luo Han Guo's lingering off-taste. Verbascoside exhibited particular effect in sweetness enhancement.

### Example XV: Evaluation of Additional Secoiridoid Glucosides and Polyphenol Compounds

A sucrose solution (4%) was added with ligustroside (5 ppm), oleuropein (5 ppm), multifloroside (5 ppm) and plantamajoside (5 ppm), respectively. Some mouthfeel, slight drying or slightly fruity effect was observed.

What is claimed is:

1. A method of enhancing the sweetness, masking the bitter off-taste and/or improving the flavor perception of a sweetness modifier comprising the step of adding to the sweetness modifier an olfactory effective amount of a compound selected from the group consisting of a secoiridoid glucoside and a polyphenol compound.

2. The method of claim 1, wherein the compound is the secoiridoid glucoside represented by Formula A set forth below: 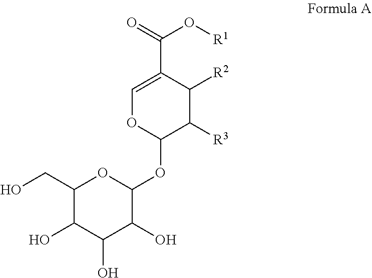
wherein R¹ represents hydrogen or a C1-8 alkyl, alkenyl or aryl optionally substituted with a hydroxyl group;
and wherein one of R² and R³ represents ethyl, ethylidene, hydroxymethyl, hydroxymethylene, hydroxyethyl, hydroxyethylidene, carboxymethyl, carboxymethylene, methoxy-2-oxoethyl, methoxy-2-oxoethylidene, acetoxyethyl or acetoxyethylidene with the other represents hydroxyphenethyl propionate or hydroxyphenethyl acrylate optionally substituted with a methoxy or an additional hydroxyl group.

3. The method of claim 2, wherein the secoiridoid glucoside is represented by Formula A′ set forth below: 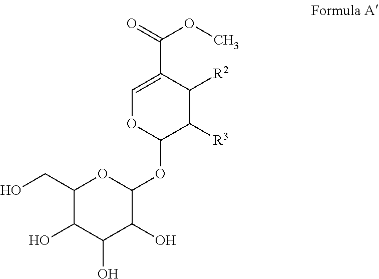
wherein one of R² and R³ represents ethyl, ethylidene, hydroxymethyl, hydroxymethylene, hydroxyethyl, hydroxyethylidene, carboxymethyl, carboxymethylene, methoxy-2-oxoethyl, methoxy-2-oxoethylidene, acetoxyethyl or acetoxyethylidene with the other represents hydroxyphenethyl propionate or hydroxyphenethyl acrylate optionally substituted with a methoxy or an additional hydroxyl group.

4. The method of claim 2, wherein the secoiridoid glucoside is selected from the group consisting of
ligujaponoside A;
persimmonoid A;
ligstroside;
oleuropein;
2-(3-hydroxy-4-methoxyphenyl)ethyl (2S,3E,4S)-3-ethylidene-2-(β-D-glucopyranosyloxy)-3,4-dihydro-5-(methoxycarbonyl)-2H-pyran-4-acetate;
demethylligstroside;
framoside;
(2″S)-10-hydroxy-2″-methoxyoleuropein;
isoligustrosidic;
a salt thereof; and
a mixture thereof.

5. The method of claim 1, wherein the compound is the polyphenol compound represented by Formula B set forth below: 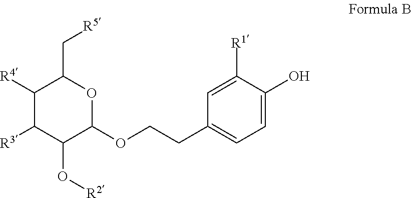
wherein R^{1′} is selected from the group consisting of hydrogen, a hydroxy group and a methoxy group;
R^{2′} is selected from the group consisting of hydrogen, an ethanone group and a sugar group;
R^{3′}, R^{4′} and R^{5′} each independently and distinctly represents a hydroxy group, 3-(3,4-dihydroxyphenyl)acrylate or the sugar group,
and wherein the sugar group is selected from the group consisting of 6-deoxy-hexopyranose, hexopyranose,6-deoxy-hexopyranose dimer and hexopyranose dimer.

6. The method of claim 5, wherein the polyphenol compound is selected from the group consisting of
ligupurpuroside A;
plantamajoside;
2′-acetylacteoside;
crassifolioside;
ligurobustoside N;
cistanoside C;
isoplantamajoside;
forsythoside;
isoforsythoside;
Isoforsythiaside;
a salt thereof; and
a mixture thereof.

7. The method of claim 1, wherein the sweetness modifier is an artificial sweetener selected from the group consisting of aspartame, sucralose, neotame, acesulfame potassium, saccharin and a combination thereof.

8. The method of claim 1, wherein the sweetness modifier is a flavoring with modifying properties selected from the group consisting of stevioside, steviolbioside rebaudioside A, rebaudioside B, rebaudioside C, rebaudioside D, rebaudioside E, rebaudioside F, dulcoside A, dulcoside B, rubusoside, alpha-glucosyl stevia, fructosyl stevia, galactosyl stevia, beta-glucosyl stevia, siamenoside, mogrosidc IV, mogroside V, Luo Han Guo, monatin, glycyrrhizic acid, thaumatin, a salt thereof, a glycosylated derivative thereof and a combination thereof.

9. The method of claim 1, wherein the olfactory effective amount is from about 1 ppb to about 1000 ppm.

10. The method of claim 1, wherein the olfactory effective amount is from about 5 ppb to about 100 ppm.

11. The method of claim 1, wherein the secoiridoid glucoside is provided as a botanical extract.

12. A composition comprising a sweetness modifier and an olfactory effective amount of a compound selected from the group consisting of a secoiridoid glucoside and a polyphenol compound.

13. The composition of claim 12, wherein the compound is the secoiridoid glucoside represented by Formula A set forth below: 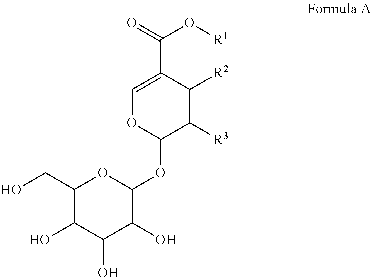
wherein R¹ represents hydrogen or a C1-8 alkyl, alkenyl or aryl optionally substituted with a hydroxyl group;
and wherein one of R² and R³ represents ethyl, ethylidene, hydroxymethyl, hydroxymethylene, hydroxyethyl, hydroxyethylidene, carboxymethyl, carboxymethylene, methoxy-2-oxoethyl, methoxy-2-oxoethylidene, acetoxyethyl or acetoxyethylidene with the other represents hydroxyphenethyl propionate or hydroxyphenethyl acrylate optionally substituted with a methoxy or an additional hydroxyl group.

14. The composition of claim 13, wherein the secoiridoid glucoside is represented by Formula A′ set forth below: 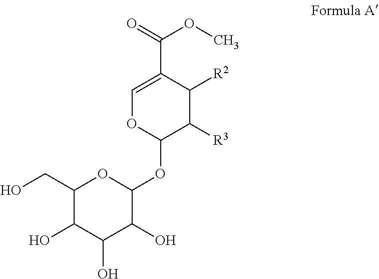
wherein one of R² and R³ represents ethyl, ethylidene, hydroxymethyl, hydroxymethylene, hydroxyethyl, hydroxyethylidene, carboxymethyl, carboxymethylene, methoxy-2-oxoethyl, methoxy-2-oxoethylidene, acetoxyethyl or acetoxyethylidene with the other represents hydroxyphenethyl propionate or hydroxyphenethyl acrylate optionally substituted with a methoxy or an additional hydroxyl group.

15. The composition of claim 14, wherein the secoiridoid glucoside is selected from the group consisting of
ligujaponoside A;
persimmonoid A;
ligstroside;
oleuropein;
2-(3-hydroxy-4-methoxyphenyl)ethyl (2S,3E,4S)-3-ethylidene-2-(β-D-glucopyranosyloxy)-3,4-dihydro-5-(methoxycarbonyl)-2H-pyran-4-acetate;
demethylligstroside;
framoside;
(2″S)-10-hydroxy-2″-methoxyoleuropein;
isoligustrosidic;
a salt thereof; and
a mixture thereof.

16. The composition of claim 12, wherein the compound is the polyphenol compound represented by Formula B set forth below: 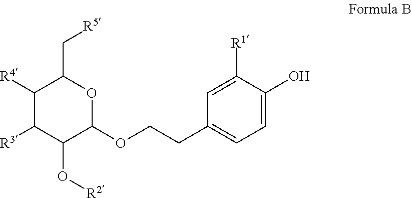
wherein R^{1′} is selected from the group consisting of hydrogen, a hydroxy group and a methoxy group;
R^{2′} is selected from the group consisting of hydrogen, an ethanone group and a sugar group;
R^{3′}, R^{4′} and R^{5′} each independently and distinctly represents a hydroxy group, 3-(3,4-dihydroxyphenyl)acrylate or the sugar group,
and wherein the sugar group is selected from the group consisting of 6-deoxy-hexopyranose, hexopyranose,6-deoxy-hexopyranose dimer and hexopyranose dimer.

17. The composition of claim 16, wherein the polyphenol compound is selected from the group consisting of
ligupurpuroside A;
plantamajoside;
2′-acetylacteoside;
crassifolioside;
ligurobustoside N;
cistanoside C;
isoplantamajoside;
forsythoside;
isoforsythoside;
Isoforsythiaside;
a salt thereof; and
a mixture thereof.

18. The composition of claim 12, wherein the sweetness modifier is an artificial sweetener selected from the group consisting of aspartame, sucralose, neotame, acesulfame potassium, saccharin and a combination thereof.

19. The composition of claim 12, wherein the sweetness modifier is a flavoring with modifying properties selected from the group consisting of stevioside, steviolbioside rebaudioside A, rebaudioside B, rebaudioside C, rebaudioside D, rebaudioside E, rebaudioside F, dulcoside A, dulcoside B, rubusoside, alpha-glucosyl stevia, fructosyl stevia, galactosyl stevia, beta-glucosyl stevia, siamenoside, mogrosidc IV, mogroside V, Luo Han Guo, monatin, glycyrrhizic acid, thaumatin, a salt thereof, a glycosylated derivative thereof and a combination thereof.

20. A consumable comprising a sweetness modifier and an olfactory effective amount of a compound selected from the group consisting of a secoiridoid glucoside and a polyphenol compound, wherein the secoiridoid glucoside is selected from the group consisting of
ligujaponoside A;
persimmonoid A;
ligstroside;
oleuropein;
2-(3-hydroxy-4-methoxyphenyl)ethyl (2S,3E,4S)-3-ethylidene-2-(β-D-glucopyranosyloxy)-3,4-dihydro-5-(methoxycarbonyl)-2H-pyran-4-acetate;
demethylligstroside;
framoside;
(2″S)-10-hydroxy-2″-methoxyoleuropein;
isoligustrosidic;
a salt thereof; and
a mixture thereof;
and wherein the polyphenol compound is selected from the group consisting of ligupurpuroside A;
plantamajoside;
2′-acetylacteoside;
crassifolioside;
ligurobustoside N;
cistanoside C;
isoplantamajoside;
forsythoside;
isoforsythoside;
Isoforsythiaside;
a salt thereof; and
a mixture thereof.
